(19) United States
(12) Patent Application Publication
(10) Pub. No.: US 2025/0343368 A1
(43) Pub. Date: Nov. 6, 2025

(54) CONNECTOR AND CABLE-END CONNECTOR

(71) Applicant: Bellwether Electronic (Kunshan) Co., Ltd., Jiangsu (CN)

(72) Inventor: Xiang-Biao TANG, Jiangsu (CN)

(21) Appl. No.: 18/796,294

(22) Filed: Aug. 7, 2024

(30) Foreign Application Priority Data
May 6, 2024 (CN) 202410551185.9

(51) Int. Cl. H01R 12/70; H01R 13/52; H01R 13/633

(52) U.S. Cl. CPC H01R 12/7023; H01R 13/5213; H01R 13/6335

(57) ABSTRACT

A connector includes a base body, a conductive part, a plurality of conductive terminals, a cap body, and a pull ring. The base body includes a docking portion and a blocking portion. The blocking portion bends to define a groove. The conductive part is accommodated in the base body. The conductive part includes a first conductive part and a second conductive part separated from the first conductive part. The first conductive part includes a first main body and a first bending portion bent from the first main body. The second conductive part includes a second main body and a second bending portion bent from the second main body. The first main body and the second main body are extended in parallel. The pull ring is pivotally connected to the base body by the blocking portion.

### CROSS-REFERENCE TO RELATED APPLICATION

This application claims priority to China Application Serial Number 202410551185.9, filed May 6, 2024, which is herein incorporated by reference in its entirety.

### BACKGROUND

### Field of Invention

The present invention relates to a connector and a cable-end connector, especially relates to a busbar clip connector and a cable-end connector.

### Description of Related Art

Generally, connectors are used to realize repeated plugging and unplugging between conductive wires and circuit boards. For instance, one connector can be disposed at a wire end, and another connector that matches the connector located at the wire end can be disposed at a circuit board end.

However, as the demand for transporting larger currents increases, the quantity of conductive terminals on the connector will increase accordingly, which will toughen the user performing plugging and unplugging of the connector between the board end and the wire end due to excessive friction. In addition, since the circuit board is usually surrounded by a housing, the design of the existing wire end connector will cause spatial interference between the wires and the housing if a distance between the circuit board and the housing is short.

Therefore, how to propose a connector and a cable-end connector that can solve the aforementioned problems is one of the problems that the industry is currently eager to invest in research and development resources to solve.

### SUMMARY

In view of this, one purpose of the present disclosure is to provide a connector and a cable-end connector that can solve the aforementioned problems.

In order to achieve the above objective, according to an embodiment of the present disclosure, a connector includes a base body, a conductive part, a plurality of conductive terminals, and a pull ring. The base body includes a docking portion. The docking portion has a plurality of openings. The conductive part is accommodated in the base body. The conductive part includes a first conductive part and a second conductive part separated from the first conductive part. Each of the first conductive part and the second conductive part has at least one through hole corresponded to the plurality of openings. The plurality of conductive terminals disposed in the at least one through hole of the first conductive part and the second conductive part. The pull ring is pivotally connected to the base body for a user hooking the pull ring to move the connector.

In one or more embodiments of the present disclosure, the base body further includes a partition plate located between the first conductive part and the second conductive part.

In one or more embodiments of the present disclosure, the base body has a blocking portion disposed on the partition plate to be pivotally connected to the pull ring.

In one or more embodiments of the present disclosure, the pull ring further includes a pivot shaft and a ring body. The pivot shaft is pivotally connected to the blocking portion. The ring body is connected to the pivot shaft.

In one or more embodiments of the present disclosure, the connector further includes a cap body engaged with the base body and covers the conductive part.

In one or more embodiments of the present disclosure, the base body has two wings laterally extending from two sides the docking portion. Each of the first conductive part and the second conductive part has a bending portion respectively accommodated in the two wings.

In one or more embodiments of the present disclosure, the cap body further includes a top plate, a positioning portion, and a side wall. The positioning portion is disposed on the top plate and is configured to be engaged with the pull ring. The side wall is bent from the top plate.

In one or more embodiments of the present disclosure, the side wall has at least one aperture and the base body further includes a bump configured to be engaged with the at least one aperture.

In one or more embodiments of the present disclosure, the base body further includes an engaging component disposed on the base body. The engaging component includes a pressing portion, an elastic arm, and a hook. The pressing portion is located on a side of the engaging component. The elastic arm is connected to the pressing portion and is located on the other side of the engaging component. The hook is connected to the elastic arm and is located on an end of the elastic arm away from the pressing portion.

In order to achieve the above objective, according to an embodiment of the present disclosure, a cable-end connector is configured to be mated with a board-end connector. The cable-end connector includes a base body, a conductive part, and a plurality of cables. The base body includes two wings, a docking portion configured for being inserted into the board-end connector, and at least one engaging component disposed on the docking portion configured for being engaged with the board-end connector. The two wings are laterally connected to two sides of the base body. The conductive part is accommodated in the base body. The conductive part includes a first conductive part and a second conductive part separated from the first conductive part. The first conductive part includes a first main body and a first bending portion bent from the first main body. The second conductive part includes a second main body and a second bending portion bent from the second main body. The first main body and the second main body are extended in parallel and respectively accommodated in the docking portion. The first bending portion and the second bending portion extend are respectively accommodated in the two wings. The plurality of cables are connected to the conductive part through the two wings.

In one or more embodiments of the present disclosure, the cable-end connector further includes a cap body engaged with the base body and covers the conductive part.

In one or more embodiments of the present disclosure, the base body further includes a partition plate located between the first conductive part and the second conductive part.

In one or more embodiments of the present disclosure, the cable-end connector further includes a pull ring pivotally connected to the base body.

In one or more embodiments of the present disclosure, the base body has a blocking portion. The pull ring has a pivot shaft pivotally connected to the blocking portion and a ring body connected to the pivot shaft.

In one or more embodiments of the present disclosure, the cable-end connector further includes a cap body engaged with the base body and covers the conductive part. The cap body further includes a top plate, a positioning portion, and a side wall. The positioning portion is disposed on the top plate and is configured to be engaged with the pull ring. The side wall is bent from the top plate.

In one or more embodiments of the present disclosure, the side wall has at least one aperture. The base body further includes a bump configured to be engaged with the at least one aperture.

In one or more embodiments of the present disclosure, the engaging component includes a pressing portion, an elastic arm, and a hook. The pressing portion is located on a side of the engaging component. The elastic arm is connected to the pressing portion and is located on the other side of the engaging component. The hook is connected to the elastic arm and is located on an end of the elastic arm away from the pressing portion.

In one or more embodiments of the present disclosure, the docking portion has a plurality of limiting slots on an outer surface thereof.

In one or more embodiments of the present disclosure, the base body has two engaging components connected to another two sides of the base body.

In one or more embodiments of the present disclosure, the cable-end connector further includes a plurality of conductive terminals disposed in the first conductive part and the second conductive part.

In summary, in the connector and the cable-end connector of the present disclosure, since the first connector has a pull ring that is pivotally connected to the first base body, so that the pull ring can drive the entire first base body detached from the second base body of the second connector when the user holds the ring body of the pull ring, so as to achieve the effect of performing plugging and unplugging with less effort. In the connector and the cable-end connector of the present disclosure, since the first bending portion of the first conductive part and the second bending portion of the second conductive part respectively extend from the first main body and the second main body, and the first bending portion and the second bending portion extend away from each other, so that the conductive wires does not interferes with the housing located around the circuit board, thereby achieving the effect of increasing the overall space utilization of the connecting structure in the housing. In the connector and the cable-end connector of the present disclosure, since the engaging component is disposed on the docking portion of the first base body, so that the hook of the engaging component can be engaged with the engaging hole of the second base body when the first connector and the second connector are combined to each other, thereby achieving the effect of enhancing the fixation between the first connector and the second connector. In the connector and the cable-end connector of the present disclosure, since the pressing portion and the hook are located on the two ends of the engaging component, and the pressing portion and the hook seesaw relative to the outer surface of the docking portion, the user can press on the pressing portion so that the elastic arm drives the hook to be detached from the engaging hole of the second base body when the user attempt to detach the first connector from the second connector, so as to achieve the effect of allowing the first connector detached from the second connector more easily.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a perspective view of a connecting structure in accordance with an embodiment of the present disclosure;

FIG. 2 is a perspective view of a first connector in accordance with an embodiment of the present disclosure;

FIG. 3 is a perspective view of a second connector in accordance with an embodiment of the present disclosure;

FIG. 4 is an exploded view of the first connector in accordance with an embodiment of the present disclosure;

FIG. 5 is a perspective view of a first base body in accordance with an embodiment of the present disclosure;

FIG. 6 is a perspective view of a first conductive terminal in accordance with an embodiment of the present disclosure;

FIG. 7 is a perspective view of a conductive part in accordance with an embodiment of the present disclosure;

FIG. 8 is a schematic view of the connecting structure in a first state in accordance with an embodiment of the present disclosure; and

FIG. 9 is a perspective view of the connecting structure in a second state in accordance with an embodiment of the present disclosure.

### DETAILED DESCRIPTION

Hereinafter, a plurality of embodiments of the present disclosure will be disclosed in diagrams. For the sake of clarity, many details in practice will be described in the following description. However, it should be understood that these details in practice should not limit present disclosure. In other words, in some embodiments of present disclosure, these details in practice are unnecessary. In addition, for simplicity of the drawings, some conventionally used structures and elements will be shown in a simple schematic manner in the drawings. The same reference numbers are used in the drawings and the description to refer to the same or like parts.

Hereinafter, the structure and function of each component included in a connecting structure CS of this embodiment and the connection relationship between the components will be described in detail.

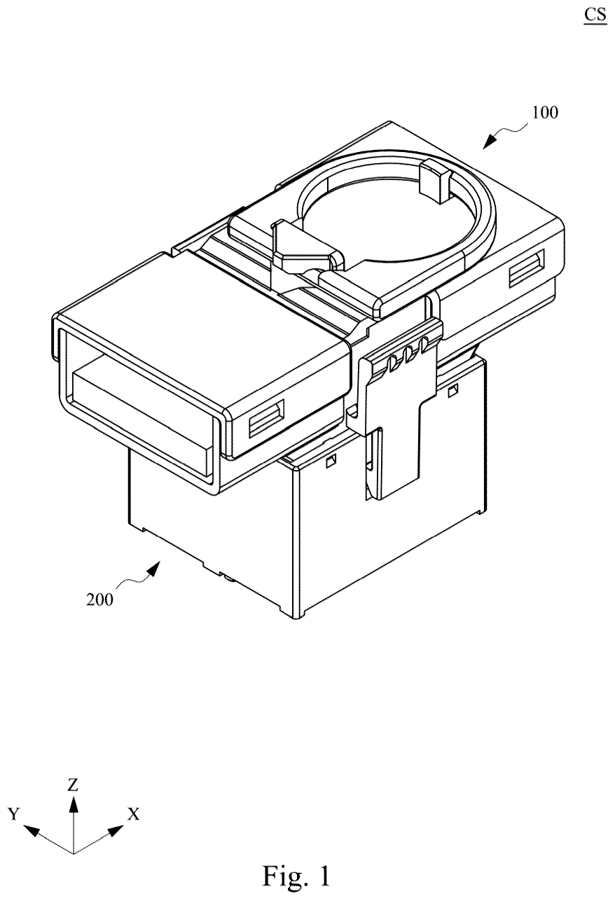

Reference is made to FIG. 1. FIG. 1 is a perspective view of a connecting structure CS in accordance with an embodiment of the present disclosure. The connecting structure CS includes a first connector 100 and a second connector 200. The second connector 200 is configured to be mated with the first connector 100. In this embodiment, the first connector 100 is configured to be electrically connected to a plurality of conductive wires (not depicted), and the second connector 200 is disposed on a circuit board (not depicted). As shown in FIG. 1, the first connector 100 moves along a mating direction (e.g., negative z-direction) to be mated with the second connector 200 and moves along an unmating direction (e.g., positive z-direction) to be detached from the second connector 200.

In some embodiments, the first connector 100 is configured as a cable-side connector, and the second connector 200 is configured as a board-side connector. In some embodiments, the second connector 200 is relatively fixed, and the first connector 100 is movable relative to the second connector 200.

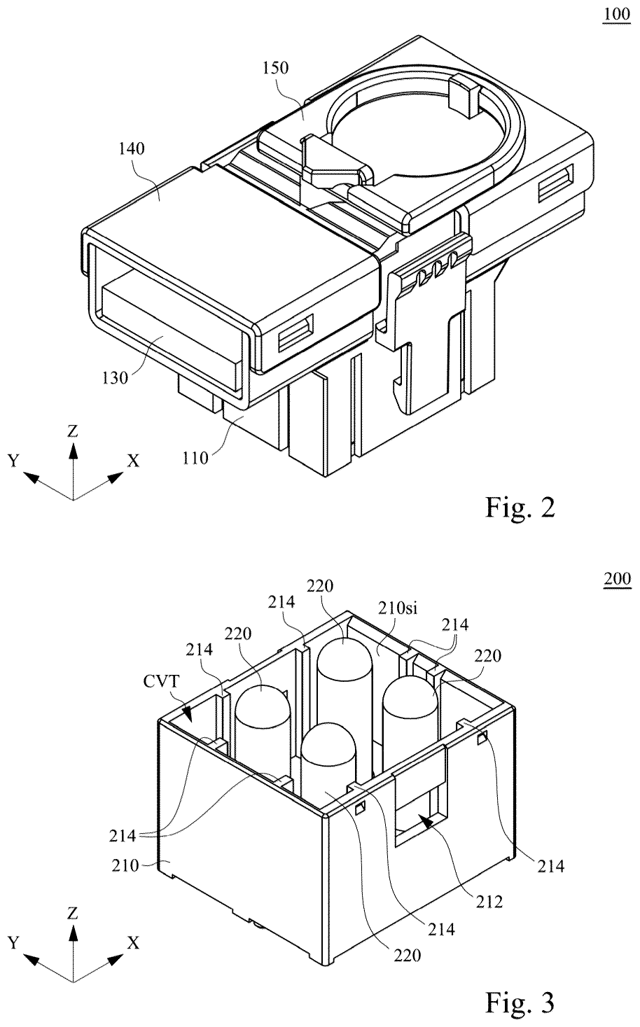

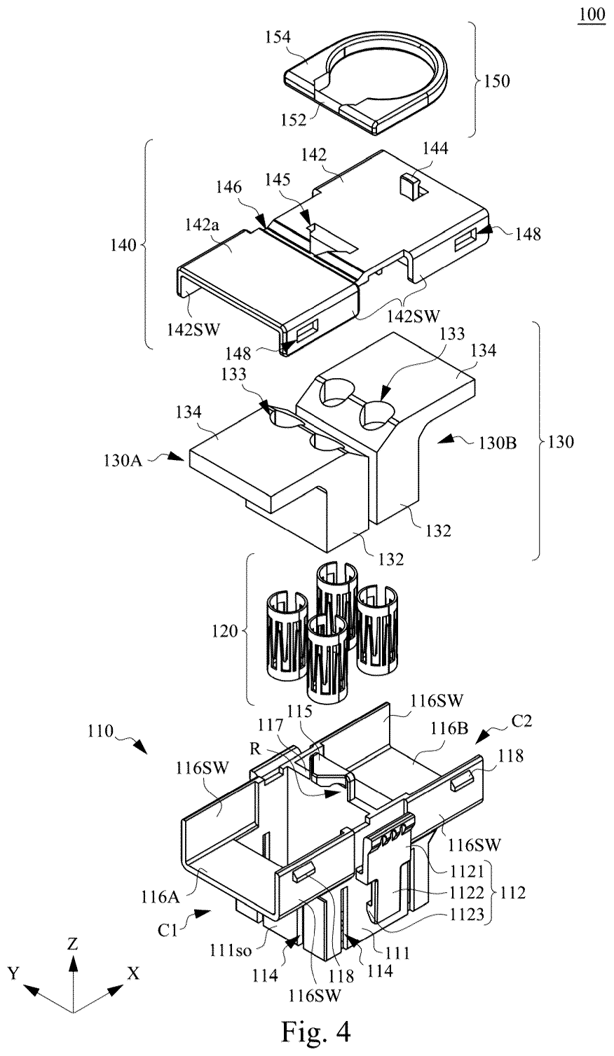

Reference is made to FIG. 2 and FIG. 4. FIG. 2 is a perspective view of the first connector 100 in accordance with an embodiment of the present disclosure. FIG. 4 is an exploded view of the first connector 100 in accordance with an embodiment of the present disclosure. As shown in FIG. 2 and FIG. 4, in this embodiment, the first connector 100 includes a first base body 110, a plurality of first conductive terminals 120, a conductive part 130, a cap body 140, and a pull ring 150. Since the first conductive terminals 120 are disposed in the conductive part 130, the first conductive terminals 120 are not depicted in FIG. 2. The conductive part 130 is accommodated in the first base body 110. The cap body 140 is engaged with the first base body 110 and covers a top of the conductive part 130 to limit the conductive part 130 in the first base body 110. Specifically, two ends of the conductive part 130 accommodated in two wings of the first connector, formed by the first base body 110 and the cap body 140, which respectively has an opening communicated with the outside. The pull ring 150 is rotatably disposed on the first base body 110. Specifically, the pull ring 150 is pivotally connected to the first base body 110.

In some embodiments, the first base body 110, the cap body 140, and the pull ring 150 may be made of insulating materials. In some embodiments, the first base body 110, the cap body 140, and the pull ring 150 may be, for example, plastic, rubber, or other suitable dielectric materials. However, the present disclosure is not intended to limit the materials of the first base body 110, the cap body 140, and the pull ring 150.

In some embodiments, the conductive part 130 may be a conductive material. In some embodiments, the conductive part 130 may be, for example, copper or other suitable metal or conductive material. However, the present disclosure is not intended to limit the material of the conductive part 130.

Reference is made to FIG. 3. FIG. 3 is a perspective view of the second connector 200 in accordance with an embodiment of the present disclosure. As shown in FIG. 3, in this embodiment, the second connector 200 includes a second base body 210 and a plurality of second conductive terminals 220. The second base body 210 has a cavity CVT configured to accommodate the first base body 110. The second base body 210 further includes an engaging hole 212 and a plurality of limiting blocks 214. The limiting blocks 214 are disposed on an inner surface 210si of the second connector 200. The limiting blocks 214 are configured to allow the first connector 100 to be limited by the second connector 200 to perform a mistake proofing function. For instance, a distance between two limiting blocks 214 on one of the side plates of the second base body 210 may be shallower, whereas a distance between two limiting blocks 214 on another one of side plates of the second base body 210 may be wider. This ensures the correctness of an adaptation direction when the first base body 110 and the second base body 210 are mated with each other. As shown in FIG. 3, the limiting blocks 214 are disposed on the inner surface 210si of the second base body 210 and extend in the cavity CVT. The second conductive terminals 220 are fixed in the second base body 210, a portion thereof is located in the cavity CVT of the second base body 210, and another portion exposes from a bottom side of the second base body 210 that are opposite to the cavity CVT for being fixed on the circuit board. The second conductive terminals 220 are configured to match the first conductive terminals 120 located in the conductive part 130.

In some embodiments, the limiting blocks 214 are elongated in the mating direction (e.g., z-direction) that is perpendicular to the circuit board. In some embodiments, the limiting blocks 214 are arranged along another direction (e.g., x-direction or y-direction).

As shown in FIG. 3, in some embodiments, the second base body 210 includes four side plates, and each of the side plates may be provided with two limiting blocks 214, and the limiting blocks 214 are arranged in such a manner protruding from the side plate to the cavity CVT in the second base body 210. However, the present disclosure is not intended to limit the quantity and the shape of the limiting blocks 214.

As shown in FIG. 3, in some embodiments, the second conductive terminals 220 are elongated in the mating direction (e.g., z-direction). In some embodiments, the mating direction may be x-direction or y-direction.

Reference is made again to FIG. 4. As shown in FIG. 4, in this embodiment, the first base body 110 includes a docking portion 111, an engaging component 112, a plurality of limiting slots 114, a blocking portion 115, an extending bottom plate 116A, an extending bottom plate 116B, an extending side plate 116SW, a partition plate 117, and a plurality of bumps 118. As shown in FIG. 3 and FIG. 4, the cavity CVT of the second base body 210 of the second connector 200 is configured to accommodate the docking portion 111 of the first base body 110.

The engaging component 112 is disposed on the first base body 110. The engaging component 112 includes a pressing portion 1121, an elastic arm 1122, and a hook 1123. The pressing portion 1121 is located at an end of the engaging component 112. The elastic arm 1122 is connected to the pressing portion 1121 and located at the other end of the engaging component 112. The hook 1123 is connected to the elastic arm 1122 and located at an end of the elastic arm 1122 away from the pressing portion 1121. As shown in FIG. 3 and FIG. 4, the engaging hole 212 of the second base body 210 is configured to be engaged with the engaging component 112. As shown in FIG. 4, the pressing portion 1121 and the hook 1123 located at the two ends of the engaging component 112. The two ends of the engaging component 112 (i.e., the pressing portion 1121 and the hook 1123) seesaw relative to an outer surface 111 so of the docking portion 111 in the y-direction. Specifically, the hook 1123 is driven by the elastic arm 1122 and seesaws with the pressing portion 1121. In some embodiments, the first base body 110 includes two engaging components 112 on two opposite sides.

The limiting slots 114 are disposed on the docking portion 111. As shown in FIG. 4, the limiting slots 114 are disposed on the outer surface 111 so of the docking portion 111. As shown in FIG. 3 and FIG. 4, the limiting slots 114 of the first base body 110 are corresponded to the plurality of limiting blocks 214 of the second base body 210.

In some embodiments, the limiting slots 114 penetrate through the docking portion 111. Specifically, the limiting slots 114 are hollowed. In some other embodiments, the limiting slots 114 are recessed from the outer surface 111 so of the docking portion 111 without penetrating the docking portion 111.

Reference is made again to FIG. 4. The extending bottom plate 116A and the extending bottom plate 116B extend outward from a top of the docking portion 111. In some embodiments, the extending bottom plate 116A and the extending bottom plate 116B extend outward in parallel. As shown in FIG. 4, specifically, the extending bottom plate 116A extends from the docking portion 111 toward the negative x-direction, and the extending bottom plate 116B extends from the docking portion 111 toward the positive x-direction. The extending side plate 116SW is vertically bent from the extending bottom plate 116A and the extending bottom plate 116B. As shown in FIG. 4, specifically, the extending side plate 116SW extends from the extending bottom plate 116A and the extending bottom plate 116B toward the positive z-direction. The bumps 118 are disposed on outer surfaces of the extending side plate 116SW.

Reference is made again to FIG. 4. The partition plate 117 is disposed in the docking portion 111. As shown in FIG. 4, specifically, the partition plate 117 extends on a plane extended in y-direction and z-direction. The blocking portion 115 is located over the docking portion 111. The blocking portion 115 is disposed on the partition plate 117. As shown in FIG. 4, the blocking portion 115 bends to define a notch R.

Reference is made again to FIG. 4. In this embodiment, the conductive part 130 includes a first conductive part 130A and a second conductive part 130B. The first conductive terminals 120 are disposed in the first conductive part 130A and the second conductive part 130B. As shown in FIG. 4, the second conductive part 130B is separated from the first conductive part 130A. Each of the first conductive part 130A and the second conductive part 130B includes a main body 132, a through hole 133, and a bending portion 134. The bending portions 134 of the first conductive part 130A and the second conductive part 130B are bent from the main body 132 of the first conductive part 130A and the second conductive part 130B, respectively. The main body 132 of the first conductive part 130A and the main body 132 of the second conductive part 130B are extended in parallel. Specifically, the main body 132 of the first conductive part 130A and the main body 132 of the second conductive part 130B both extend in the z-direction. An extending direction of the bending portion 134 of the first conductive part 130A is perpendicular to an extending direction of the main body 132 of the first conductive part 130A. An extending direction of the bending portion 134 of the second conductive part 130B is perpendicular to an extending direction of the main body 132 of the second conductive part 130B. The bending portion 134 of the first conductive part 130A and the bending portion 134 of the second conductive part 130B extend away from each other from the main body 132 of the first conductive part 130A and the main body 132 of the second conductive part 130B, respectively. As shown in FIG. 4, specifically, the bending portion 134 of the first conductive part 130A extends from the main body 132 of the first conductive part 130A toward the negative x-direction. The bending portion 134 of the second conductive part 130B extends from the main body 132 of the second conductive part 130B toward the positive x-direction. The through holes 133 of the first conductive part 130A and the through holes 133 of the second conductive part 130B are configured to accommodate the first conductive terminals 120.

In some embodiments, the first conductive part 130A and the second conductive part 130B are accommodated in the first base body 110. The partition plate 117 is located between the first conductive part 130A and the second conductive part 130B. In other words, the second conductive part 130B is separated from the first conductive part 130A by the partition plate 117.

In some embodiments, one of the first conductive part 130A and the second conductive part 130B is coupled to a conductive wire (not depicted) for transmitting a positive voltage potential, and the other one of the first conductive part 130A and the second conductive part 130B is coupled to a conductive wire (not depicted) for transmitting a negative voltage potential or a ground potential.

Reference is made again to FIG. 4. In this embodiment, the cap body 140 includes a top plate 142, a side wall 142SW, a positioning portion 144, a via 145, and an aperture 148. The positioning portion 144 is disposed on the top plate 142 and is configured to be engaged with the pull ring 150. In some embodiments, the positioning portion 144 protrudes from a top surface 142a of the top plate 142. The side wall 142SW is bent from the top plate 142. The via 145 is located on the top plate 142. The via 145 is configured to allow the blocking portion 115 of the first base body 110 to pass through. In some embodiments, the via 145 is separated from the positioning portion 144. As shown in FIG. 4, the side wall 142SW has the aperture 148. The bumps 118 of the first base body 110 are corresponded to a plurality of apertures 148, and the bumps 118 are configured to be engaged with the apertures 148 to fix the cap body 140 with the first base body 110.

In some embodiments, the first base body 110 and the cap body 140 are combined to define a space accommodating the first conductive part 130A and the second conductive part 130B, and further define a first channel C1 accommodating the first conductive part 130A and a second channel C2 accommodating the second conductive part 130B by the partition plate 117.

Reference is made again to FIG. 4. In this embodiment, the pull ring 150 is pivotally connected to the first base body 110 by the notch R limited by the blocking portion 115 and the top plate 142. The top plate 142 may have a groove 146 along the Y-axis opposite to the notch R. The pull ring 150 includes a pivotal shaft 152 and a ring body 154. The pivot shaft 152 is accommodated in the notch R and the groove 146 and is pivotally connected to the blocking portion 115. The ring body 154 is connected to the pivot shaft 152 and is engaged with the pull ring 150 for fixing the pull ring 150 on the cap body 140.

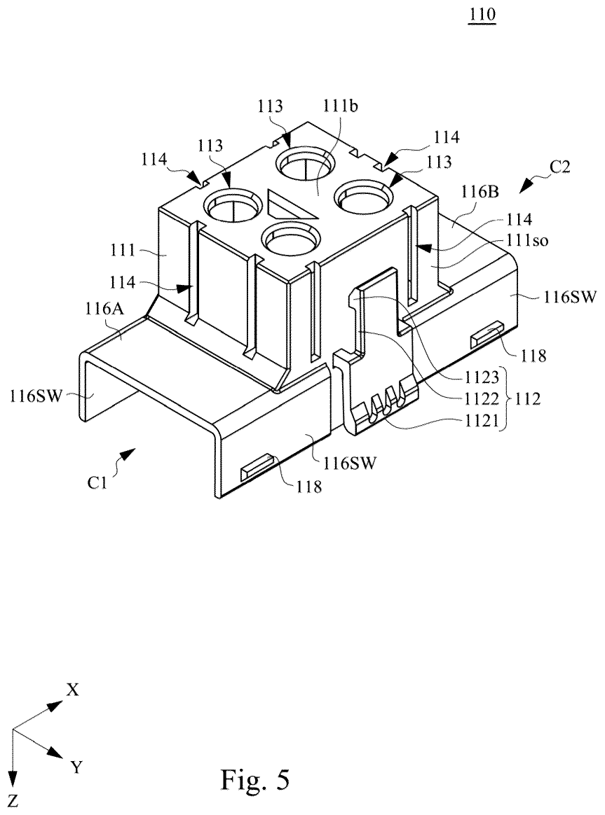

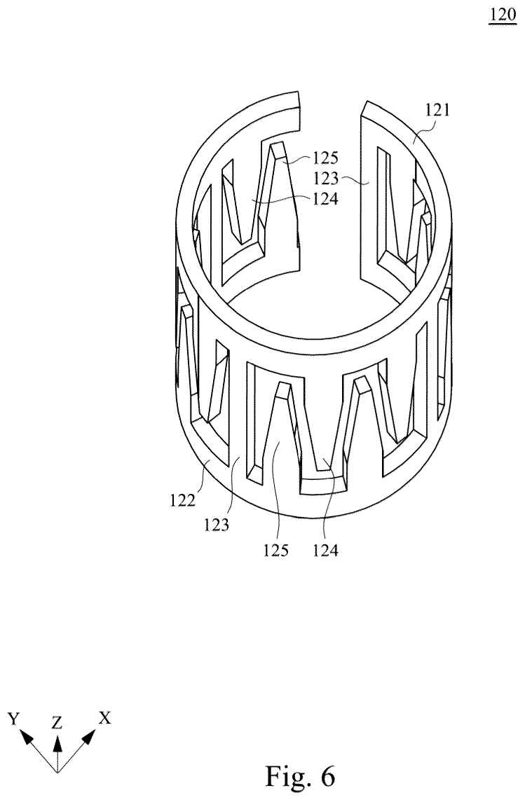

Reference is made to FIG. 5. FIG. 5 is a perspective view of the first base body 110 in accordance with an embodiment of the present disclosure. As shown in FIG. 5, in this embodiment, the first base body 110 further has a plurality of openings 113. The openings 113 penetrate through a bottom surface 111b of the docking portion 111. The openings 113 are corresponded to the through holes 133 and the second conductive terminals 220.

Reference is made to FIG. 6. FIG. 6 is a perspective view of the first conductive terminal 120 in accordance with an embodiment of the present disclosure. As shown in FIG. 6, in this embodiment, the first conductive terminal 120 is annular and includes a top ring 121, a bottom ring 122, a plurality of connecting bridges 123, a plurality of top tongue portions 124, and a plurality of bottom tongue portions 125. The top ring 121 is located over the bottom ring 122.

The connecting bridges 123 are connected between the top ring 121 and the bottom ring 122. In some embodiments, a center of the connecting bridges 123 is bent toward the inside of the first conductive terminal 120. The top tongue portions 124 extend from the top ring 121 toward the bottom ring 122.

Specifically, an end of the top tongue portions 124 is connected to the top ring 121, and the other end of the top tongue portions 124 is suspended. The bottom tongue portions 125 extend from the bottom ring 122 toward the top ring 121. Specifically, an end of the bottom tongue portions 125 is connected to the bottom ring 122, and the other end of the bottom tongue portions 125 is suspended. Since the first conductive terminal 120 further includes the plurality of top tongue portions 124 and the bottom tongue portions 125 in addition to the connecting bridges 123, a contact area between the first conductive terminals 120 and the second conductive terminals 220 can be increased when the second conductive terminals 220 pass through the conductive part 130 and contact the first conductive terminals 120, so as to meet the requirement of transmitting large current.

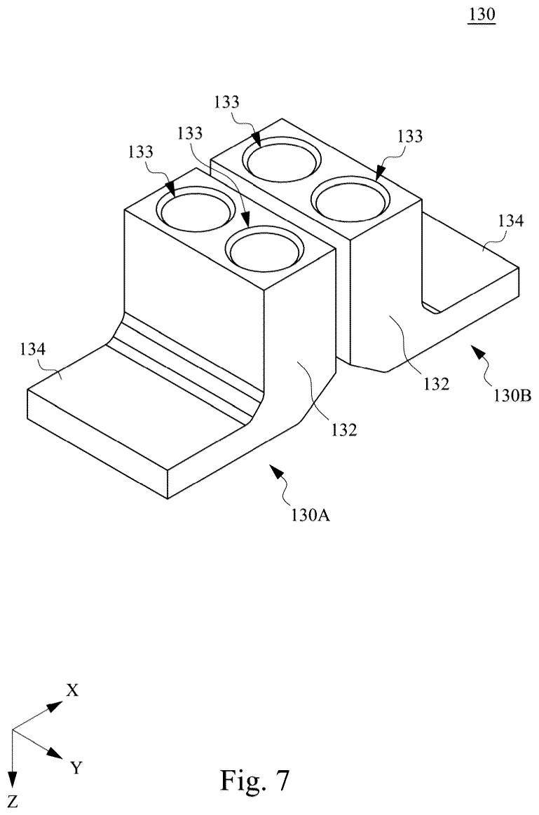

Reference is made to FIG. 7. FIG. 7 is a perspective view of the conductive part 130 in accordance with an embodiment of the present disclosure. As shown in FIG. 4 and FIG. 7, in this embodiment, the through holes 133 penetrate through the first conductive part 130A and the second conductive part 130B. In some embodiments, the through holes 133 penetrate through portions of the main body 132 and the bending portion 134. In some embodiments, the through holes 133 extend along a direction (e.g., z-direction).

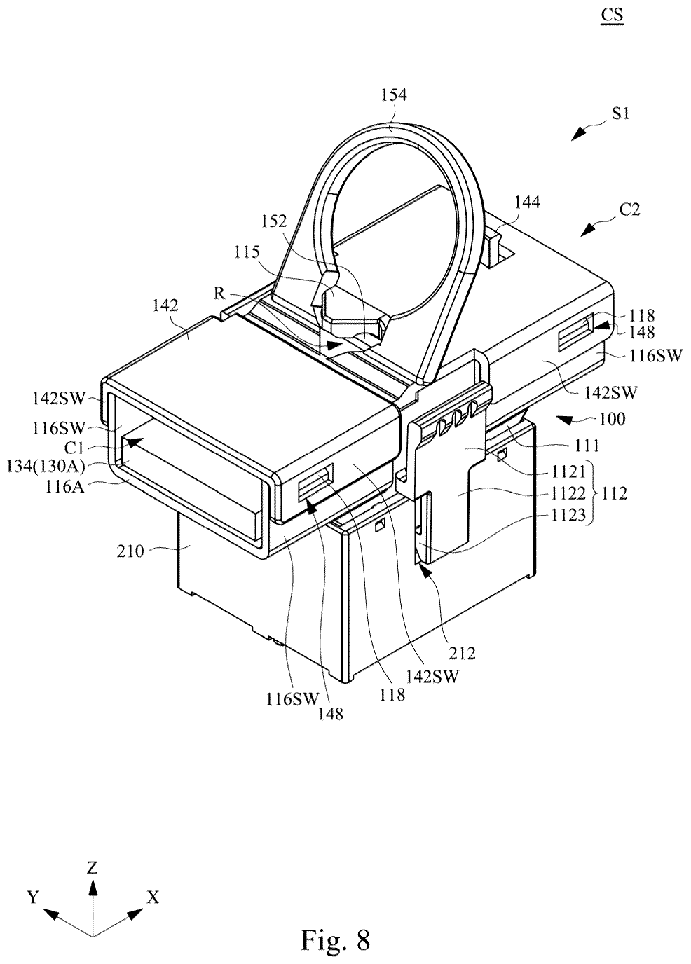

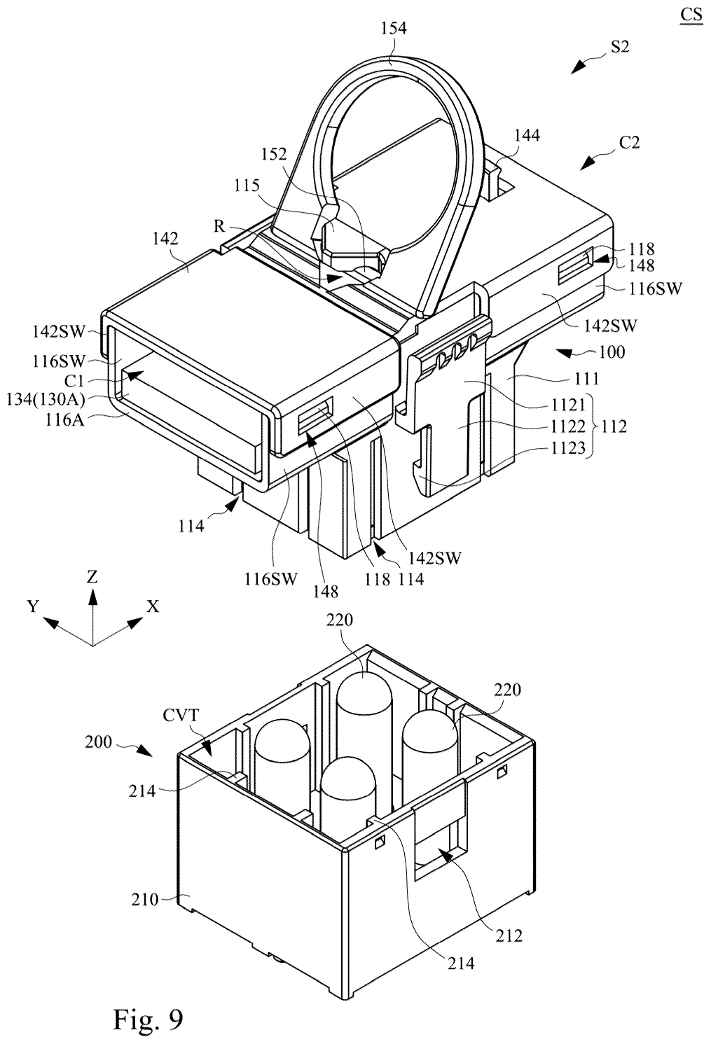

Reference is made to FIG. 8. FIG. 8 is a schematic view of the connecting structure CS in a first state S1 in accordance with an embodiment of the present disclosure. As shown in FIG. 8, in this embodiment, the connecting structure CS has the first state S1 and a second state S2 different from the first state S1. The first connector 100 moves relative to the second connector 200 between the first state S1 and the second state S2. Details about the second state S2 will be explained below with respect to FIG. 9. As shown in FIG. 8, when the connecting structure CS is in the first state S1, the docking portion 111 is located in the second base body 210. The hook 1123 of the engaging component 112 is engaged with the engaging hole 212 of the second base body 210.

Reference is made to FIG. 9. FIG. 9 is a schematic view of the connecting structure CS in the second state S2 in accordance with an embodiment of the present disclosure. When the connecting structure CS is in the second state S2, the hook 1123 of the engaging component 112 is detached from the engaging hole 212 of the second base body 210, and the docking portion 111 of the first base body 110 is also detached from the second base body 210, thereby the first connector 100 being detached from the second connector 200.

The following will describe in detail how the user combines the first connector 100 with the second connector 200 and how to detach the first connector 100 from the second connector 200.

Reference is made to FIG. 8 and FIG. 9. In a usage scenario, as shown in FIG. 8, the user can grip the first connector 100 at first to abut against the second connector 200, so that the docking portion 111 of the first base body 110 enters the second base body 210. In addition, the second conductive terminals 220 enter the through holes 133 of the conductive part 130 and contact the first conductive terminals 120. Next, as shown in FIG. 8, the user can continue to push the first connector 100 moving toward the second connector 200 along a direction (e.g., z-direction), so that the hook 1123 enters the engaging hole 212.

Specifically, since the elastic arm 1122 has elasticity, the elastic arm 1122 can drive the hook 1123 to be in close contact with the outer surface 111 so of the first base body 110 by an elastic restoring force, thereby allowing the hook 1123 to enter the engaging hole 212. Accordingly, the first connector 100 and the second connector 200 are mated with each other, so that the connecting structure CS is in the first state S1.

In a usage scenario, as shown in FIG. 9, when the connecting structure CS alters to the second state S2 from the first state S1, the user grips the first connector 100 to move toward a direction away from the second connector 200. In a preferred usage scenario, the user can utilize the pulp of the thumb and the pulp of the middle finger to simultaneously press the pressing portion 1121 of the engaging component 112 on both sides of the docking portion 111, and at the same time utilize the index finger to hook the ring body 154 of the pull ring 150. When the user presses the pressing portion 1121, the elastic arm 1122 drives the hook 1123 to move in a direction away from the docking portion 111, so that the hook 1123 is detached from the engaging hole 212. Next, after the hook 1123 is detached from the engaging hole 212, the user applies the force from the index finger alone to hook the pull ring 150 to move the first connector 100 away from the second connector 200. Alternatively, the user simultaneously applies the force of the index finger to hook the pull ring 150 and the gripping force of the thumb and the middle finger to move the first connector 100 away from the second connector 200. Next, the user continues to apply force to detach the first connector 100 from the second connector 200. Accordingly, the first connector 100 is detached from the second connector 200 so that the connecting structure CS is in the second state S2.

In some embodiments, if the user attempts to retain the connecting structure CS in the first state S1 or the second state S2, the user can collapse the pull ring 150 so that the ring body 154 is engaged with the positioning portion 144 (as shown in FIG. 1).

From the above detailed description of the specific embodiments of the present disclosure, it can be clearly seen that in the connector and the connecting structure of the present disclosure, since the first connector has a pull ring that is pivotally connected to the first base body, so that the pull ring can drive the entire first base body detached from the second base body of the second connector when the user holds the ring body of the pull ring, so as to achieve the effect of performing plugging and unplugging with less effort. In the connector and the connecting structure of the present disclosure, since the first bending portion of the first conductive part and the second bending portion of the second conductive part respectively extend from the first main body and the second main body, and the first bending portion and the second bending portion extend away from each other, so that the conductive wires does not interferes with the housing located around the circuit board, thereby achieving the effect of increasing the overall space utilization of the connecting structure in the housing. In the connector and the connecting structure of the present disclosure, since the engaging component is disposed on the docking portion of the first base body, so that the hook of the engaging component can be engaged with the engaging hole of the second base body when the first connector and the second connector are combined to each other, thereby achieving the effect of enhancing the fixation between the first connector and the second connector. In the connector and the connecting structure of the present disclosure, since the pressing portion and the hook are located on the two ends of the engaging component, and the pressing portion and the hook seesaw relative to the outer surface of the docking portion, the user can press on the pressing portion so that the elastic arm drives the hook to be detached from the engaging hole of the second base body when the user attempt to detach the first connector from the second connector, so as to achieve the effect of allowing the first connector detached from the second connector more easily.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A connector, comprising:
a base body comprising a docking portion, and the docking portion having a plurality of openings;
a conductive part accommodated in the base body, the conductive part comprising a first conductive part and a second conductive part separated from the first conductive part, wherein each of the first conductive part and the second conductive part has at least one through hole corresponded to the plurality of openings;
a plurality of conductive terminals disposed in the at least one through hole of the first conductive part and the second conductive part; and
a pull ring pivotally connected to the base body for a user hooking the pull ring to move the connector.

2. The connector of claim 1, wherein the base body further comprises a partition plate located between the first conductive part and the second conductive part.

3. The connector of claim 2, wherein the base body has a blocking portion disposed on the partition plate to be pivotally connected to the pull ring.

4. The connector of claim 3, wherein the pull ring further comprises:
a pivot shaft pivotally connected to the blocking portion; and
a ring body connected to the pivot shaft.

5. The connector of claim 1, further comprising a cap body engaged with the base body and covering the conductive part.

6. The connector of claim 5, wherein the base body has two wings laterally extending from two sides the docking portion, and each of the first conductive part and the second conductive part has a bending portion respectively accommodated in the two wings.

7. The connector of claim 6, wherein the cap body further comprises:
a top plate;
a positioning portion disposed on the top plate and configured to be engaged with the pull ring; and
a side wall bent from the top plate.

8. The connector of claim 7, wherein the side wall has at least one aperture and the base body further comprises a bump configured to be engaged with the at least one aperture.

9. The connector of claim 1, wherein the base body further comprises an engaging component disposed on the base body, and the engaging component comprises:
a pressing portion located on a side of the engaging component;
an elastic arm connected to the pressing portion and located on the other side of the engaging component; and
a hook connected to the elastic arm and located on an end of the elastic arm away from the pressing portion.

10. A cable-end connector configured to be mated with a board-end connector, comprising:
a base body comprising two wings, a docking portion configured for being inserted into the board-end connector, and at least one engaging component disposed on the docking portion configured for being engaged with the board-end connector, the two wings laterally connected to two sides of the base body;
a conductive part accommodated in the base body, the conductive part comprising a first conductive part and a second conductive part separated from the first conductive part, wherein the first conductive part comprises a first main body and a first bending portion bent from the first main body, and the second conductive part comprises a second main body and a second bending portion bent from the second main body, wherein the first main body and the second main body are extended in parallel and respectively accommodated in the docking portion, and the first bending portion and the second bending portion extend are respectively accommodated in the two wings; and
a plurality of cables connected to the conductive part through the two wings.

11. The cable-end connector of claim 10, further comprising a cap body engaged with the base body and covering the conductive part.

12. The cable-end connector of claim 10, wherein the base body further comprises a partition plate located between the first conductive part and the second conductive part.

13. The cable-end connector of claim 10, further comprising a pull ring pivotally connected to the base body.

14. The cable-end connector of claim 13, wherein the base body has a blocking portion, and the pull ring has a pivot shaft pivotally connected to the blocking portion and a ring body connected to the pivot shaft.

15. The cable-end connector of claim 14, further comprising a cap body engaged with the base body and covering the conductive part, wherein the cap body further comprises:
a top plate;
a positioning portion disposed on the top plate and configured to be engaged with the pull ring; and
a side wall bent from the top plate.

16. The cable-end connector of claim 15, wherein the side wall has at least one aperture and the base body further comprises a bump configured to be engaged with the at least one aperture.

17. The cable-end connector of claim 10, wherein the engaging component comprises:
a pressing portion located on a side of the engaging component;
an elastic arm connected to the pressing portion and located on the other side of the engaging component; and
a hook connected to the elastic arm and located on an end of the elastic arm away from the pressing portion.

18. The cable-end connector of claim 10, wherein the docking portion has a plurality of limiting slots on an outer surface thereof.

19. The cable-end connector of claim 10, wherein the base body has two engaging components connected to another two sides of the base body.

20. The cable-end connector of claim 10, further comprising a plurality of conductive terminals disposed in the first conductive part and the second conductive part.
